(19) United States
(12) Patent Application Publication
(10) Pub. No.: US 2014/0053251 A1
(43) Pub. Date: Feb. 20, 2014

(54) USER ACCOUNT RECOVERY

(71) Applicants: You Lei Chen, Beijing (CN); Jin Liu, Beijing (CN); Shao Jun Sun, Beijing (CN)

(72) Inventors: You Lei Chen, Beijing (CN); Jin Liu, Beijing (CN); Shao Jun Sun, Beijing (CN)

(73) Assignee: NOKIA SIEMENS NETWORKS OY, Espoo (FI)

(21) Appl. No.: 13/876,073

(22) PCT Filed: Sep. 27, 2010
(86) PCT No.: PCT/CN2010/001505

§ 371 Date: Nov. 5, 2013

(51) Int. Cl. H04L 29/06

(52) U.S. Cl. CPC H04L 63/08
USPC 726/6

(57) ABSTRACT

A user account recovery method is described. The method includes storing an account recovery token at both an identity management system (IDM) and a service provider. In response to an indication that a user cannot access an account, a request for the account recovery token is sent by the relevant service provider to the IDM. On confirming the identity of the user, the IDM retrieves the account recovery token and returns the token to the service provider. The service provider compares the token received from the IDM with one or more locally stored tokens to initiate an account recovery process (which process may, for example, include prompting the user to provide a new password for the account).

The invention is directed to user account recovery. In particular, the invention is directed to the use of an identity management system (IDM) to assist in user account recovery.

### BACKGROUND TO THE INVENTION

As a simple and convenient authentication method, a username and password pair is the most widely used authentication approach among online service providers (SPs). It is entirely possible for a single user to own tens, or even hundreds, of user accounts among different service providers. As the number of different authentication requirements (such as username and password pairs) increases, the likelihood of access difficulties (for example due to a user forgetting his password or even his username) for a particular service provider increases significantly.

Many service providers provide mechanisms to enable users to retrieve credential information, such as usernames and/or passwords. A number of existing methods to enable users to retrieve user account information are discussed below.

In a first method, a user registers a valid e-mail account at the service provider. When the user tries to recover the password, an e-mail is sent to the e-mail account that enables the user to reset his/her password. A problem with this approach is that the user must expose details of his/her e-mail account to the service provider, which the user may not be willing to do. Moreover, the user's e-mail account/password might also be forgotten. Furthermore, a potential danger with such an arrangement is that if an unauthorized third party gains access to the user's e-mail account, that third party may be able to gain access to one or more of the user's online service provider accounts. In a worst case scenario, the user may lose all control of the related accounts.

In a second method, a user is asked to register a mobile phone number at the service provider so that, in the case of password recovery, a new one time validation string or temporary password can be sent to the user's mobile phone and the online service provider can instruct the user to input the sent string or password. This method requires the use of the user's mobile phone number, which, as with the email account details referred to above, the user may be unwilling to provide. Moreover, such a solution results in costs being incurred by the service provider (when sending messages to the user), which may prevent the user or service provider from adopting such a solution. Furthermore, such an arrangement may not be suitable for international online service providers, since the service provider may need to set up different SMS adaptors for different country operators.

In a third method, a user registers a set of questions with answers. The user can be asked to respond to the questions in order to recover his/her password. A user may be reluctant to provide these sorts of personal details to an untrusted online service provider. Moreover, the answers to such questions are often easy to guess by other people familiar with the user. Furthermore, the user may forget the answer to some of the questions, which may result in a legitimate user being blocked from accessing an account.

In a fourth method, a user is requested to register his/her real citizen number or ID card number, birth date and so on. On password recovery these kinds of questions are challenged.

In such an arrangement, users, due to privacy concerns, often register fake details. When a password recovery process is used, the user has typically forgotten those fake details and so cannot proceed with the account recovery process.

The present invention seeks to address at least some of the problems outlined above.

### SUMMARY OF THE INVENTION

The present invention provides a method (such as a method for recovering a user account) comprising: receiving, at a service provider, an account recovery request (typically from a user seeking account recovery); sending a request for a first account recovery token to an identity management system; receiving the first account recovery token from said identity management system; comparing the received first account recovery token with one or more second account recovery tokens to which the service provider has access (typically stored at the service provider or stored within a database to which the service provider has access); and in the event that one of said one or more second account recovery tokens matches said first account recovery token, recovering a user account associated with said one of said one or more second account recovery tokens.

The present invention also provides an apparatus (e.g. a service provider or a server) comprising: a first input configured to receive an account recovery request; a first output configured to send a request for a first account recovery token to an identity management system (the user account may or may not be identified in the request); a second input configured to receive the first account recovery token from said identity management system; a first processor (or some other comparison means or comparator) configured to compare the first account recovery token with one or more second account recovery tokens to which the service provider has access (those second account recovery tokens typically being stored at the service provider or stored within a database to which the service provider has access); and a second processor (which may be the same as the first processor) configured, in the event that one of said one or more second account recovery tokens matches said first account recovery token, to recover a user account associated with said one of said one or more second account recovery tokens. The apparatus may include a user interface configured to prompt the user to identify an IDM and/or to prompt the user to reset a credential for the user.

Thus, the present invention provides an account recovery mechanism in which the user's privacy is increased when compared with many prior art arrangements. For example, the user need not provide privacy information such as email account details, mobile phone number, birthday data, responses to common question etc, to the service provider.

In one form of the invention, the invention is implemented in accordance using the OAuth protocol. However, this is not essential to all forms of the invention.

Recovering the user account may take many different forms. By way of example, recovering the user account may comprise prompting the user to reset a credential for the user account. In some forms of the invention, recovering the user account may comprise informing the user of at least some credentials for the user account. By way of example, the user may be informed of the username and prompted to reset the password. In an alternative form of the invention, recovering the user account may comprise sending a reset user credential (e.g. a reset password) for the user account to said user.

The account recovery request may identify a user account. However, this is not essential to all forms of the invention. For example, the user may be unable to provide any credentials information for his account. In such a scenario, the identity of the user (as determined by the identity management system) may be all that it used to identify the account.

The invention may include prompting the user to identify the identity management system. For example, the user may be prompted to identify the identity management system by selecting one of many possible IDMs, for example from a dropdown list or by providing a URL for the user's preferred IDM.

In some forms of the invention, the account recovery request is initiated by a user. Moreover, the said request for a first account recovery token may identify the said user. Alternatively, or in addition, the request for a first account recovery token may be sent to the identity management system via the user.

The request for a first account recovery token may be sent directly to the relevant identity management system, or may be sent via a user that initiated the account recovery request (e.g. using redirection).

The first account recovery token may be created as part of an account setup procedure. The second account recovery token may simply be a copy of the first account recovery token.

The present invention also provides a method (such as a method for obtaining an account recovery token) comprising: receiving, at an identity management system, a request for a first account recovery token associated with a user; authenticating the user; retrieving the first account recovery token based on the identity of the user and based on the identity of a service provider requesting said first account recovery token; and sending the retrieved first account recovery token in response to said request.

The present invention further provides an apparatus (such as an identity management system) comprising: a first input configured to receive a request for a first account recovery token associated with a user; a first processor configured to authenticate said user; a second processor (which may be the same as the first processor) configured to retrieve the first account recovery token based on the identity of the user and based on the identity of a service provider that requires said first account recovery token (the first account recovery token typically being stored at the identity management system or at a database to which the identity management system has access); and a first output configured to send said retrieved first account recovery token in response to said request.

The request for a first account recovery token may be sent from a service provider to the identity management system via the user using redirection. In this embodiment, the user may be identified by being the source of the request received at the identity management system; the request itself may not provide the identity of the user.

The first account recovery token may be created as part of an account setup procedure. The second account recovery token may simply be a copy of the first account recovery token.

The request for a first account recovery token may include at least some account information (such as a username), but this is not essential.

In some forms of the invention, the request for a first account recovery token identifies said user. Alternatively, or in addition, the request for a first account recovery token may identify the service provider. The request may be sent directly from the service provider to the IDM (thereby making identifying the service provider simple). In such a scenario, the request may explicitly identify the user.

The invention provides a user account recovery method. The method includes storing an account recovery token at both an identity management system (IDM) and a service provider. In response to an indication that a user cannot access an account, a request for the account recovery token is sent by the relevant service provider to the IDM. On confirming the identity of the user, the IDM retrieves the account recovery token and returns the token to the service provider. The service provider compares the token received from the IDM with a locally stored token to initiate an account recovery process (which process may, for example, include prompting the user to provide a new password for the account).

The present invention further provides a system comprising a service provider and an identity management system, wherein the service provider comprises: a first input configured to receive an account recovery request; a first output configured to send a request for a first account recovery token to the identity management system (the user account may or may not be identified in the request); a second input configured to receive the first account recovery token from said identity management system; a first processor (or some other comparison means or comparator) configured to compare the first account recovery token with one or more second recovery tokens to which the service provider has access (typically stored at the service provider or stored within a database to which the service provider has access); and a second processor (which may be the same as the first processor) configured, in the event that one of said one or more second recovery tokens matches said first account recovery token, to recover a user account associated with said one of said one or more second recovery tokens, and wherein the identity management system comprises a first input configured to receive the request from the service provider for the first account recovery token associated with a user; a first processor configured to authenticate said user; a second processor (which may be the same as the first processor) configured to retrieve the first account recovery token based on the identity of the user and based on the identity of a service provider that requires said first account recovery token (the first account recovery token is typically stored at the IDM or at a database to which the IDM has access); and a first output configured to send said retrieved first account recovery token to the service provider in response to said request.

The present invention also provides a computer program comprising: code (or some other means) for receiving, at a service provider, an account recovery request; code (or some other means) for sending a request for a first account recovery token to an identity management system; code (or some other means) for receiving the first account recovery token from said identity management system; code (or some other means) for comparing the received first account recovery token with one or more second account recovery tokens to which the service provider has access (said second account recovery tokens typically being stored at the service provider or stored within a database to which the service provider has access); and code (or some other means) for recovering, in the event that one of said one or more second account recovery tokens matches said first account recovery token, a user account associated with said one of said one or more second account recovery tokens. The computer program may be a computer program product comprising a computer-readable medium bearing computer program code embodied therein for use with a computer.

The present invention yet further provides a computer program comprising: code (or some other means) for receiving, at an identity management system, a request for a first account recovery token associated with a user; code (or some other means) for authenticating a user; code (or some other means) for retrieving the first account recovery token based on the identity of the user and based on the identity of a service provider requesting said first account recovery token; and code (or some other means) for sending said retrieved first account recovery token in response to said request. The computer program may be a computer program product comprising a computer-readable medium bearing computer program code embodied therein for use with a computer.

### BRIEF DESCRIPTION OF THE DRAWINGS

Exemplary embodiments of the invention are described below, by way of example only, with reference to the following numbered schematic drawings.

FIG. 1 is a block diagram of a system in which the present invention may be used;

FIG. 2 shows a message sequence of an exemplary registering process in accordance with an aspect of the present invention;

FIG. 3 shows a message sequence of an exemplary registering process in accordance with an aspect of the present invention;

FIG. 4 shows a message sequence of an exemplary recovery process in accordance with an aspect of the present invention;

FIG. 5 shows a message sequence of an exemplary recovery process in accordance with an aspect of the present invention;

FIG. 6 shows a message sequence of an exemplary registering process in accordance with an aspect of the present invention;

FIG. 7 shows a message sequence of an exemplary recovery process in accordance with an aspect of the present invention;

FIG. 8 is a block diagram of a service provider in accordance with an aspect of the present invention; and

FIG. 9 is a block diagram of an identity management system in accordance with an aspect of the present invention.

### DETAILED DESCRIPTION OF ONE OR MORE EMBODIMENTS

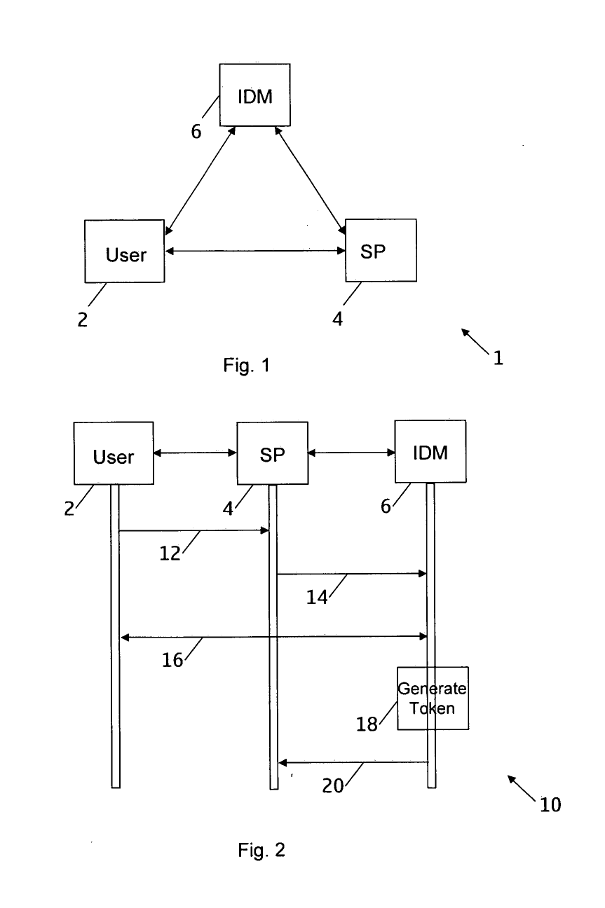

FIG. 1 is a block diagram, indicated generally by the reference numeral 1, in which the present invention may be used.

The system 1 comprises a user 2, a service provider 4 and an identity management system (IDM) 6. The user 2 is in two-way communication with both the service provider 4 and the IDM 6.

The service provider 4 is in two-way communication with the IDM 6.

In order to obtain access to the service provider 4, the user 2 is required to provide user credentials. Such user credentials may take the form of a username and password pair, but many alternative suitable user credentials will be apparent to those skilled in the art.

In the event that the user 2 forgets the user credentials required to access the service provider 4, the user can make use of the IDM 6 in order to obtain access to the service provider, as described in detail below.

The account recovery process of the present invention includes two stages: registering and recovery.

The registering step happens when the user 2 is logged into the service provider 4 or otherwise registered to the service provider. An exemplary registering process involves the following steps:

1. The IDM 6 generates a recovery token in response to a request from the service provider 4. The recovery token is unique and is known only to the service provider 4 and the IDM 6. The IDM 6 stores the recovery token, together with an identity for the service provider (such as a URL for the service provider).

2. The service provider 4 receives the recovery token from the IDM 6 and stores the recovery token, along with the user's credentials (e.g. the username-password pair for the user).

The recovery process involves the following steps:

1. The user 2 asks the service provider 4 to recover an account at the service provider.

2. The service provider 4 obtains (typically from the user 2) the details of the relevant IDM (i.e. the IDM 6) from which the recovery token can be obtained.

3. The service provider 4 asks the IDM 6 to provide the recovery token.

4. The IDM 6 authenticates the user 2.

5. The IDM 6 provides the recovery token in response to the request from the service provider 4. The recovery token is selected from all the recovery tokens stored at the IDM on the basis of the identity of the user 2 (identified in the step 3 above) and the service provider 4 (from whom the original request was received at the IDM 6 at step 2 above).

6. The service provider 4 compares the recovery token provided by the IDM 6 with one or more recovery tokens stored locally at the service provider and, if a match is found, the user 2 is given access to the relevant account (i.e. that account is “recovered”).

By way of example, FIG. 2 shows a message sequence, indicated generally by the reference numeral 10, of an exemplary registering process in accordance with an aspect of the present invention. The message sequence 10 starts at step 12 where the user 2 logs into a user account at the service provider 4. Next the service provider sends a request 14 to the IDM 6 requesting an account recovery token. In response to the request 14, the IDM contacts the user 2 and authenticates the user (step 16). The user authentication step 16 can take many different forms, such as the provision of a username-password pair, the use of SIM data, or the use of biometric data.

Once the IDM 6 has authenticated the user 2, the IDM generates and stores a recovery token (at step 18). The IDM 6 then sends the recovery token to the service provider 4 in a message 20, which message is sent in response to the original request 14.

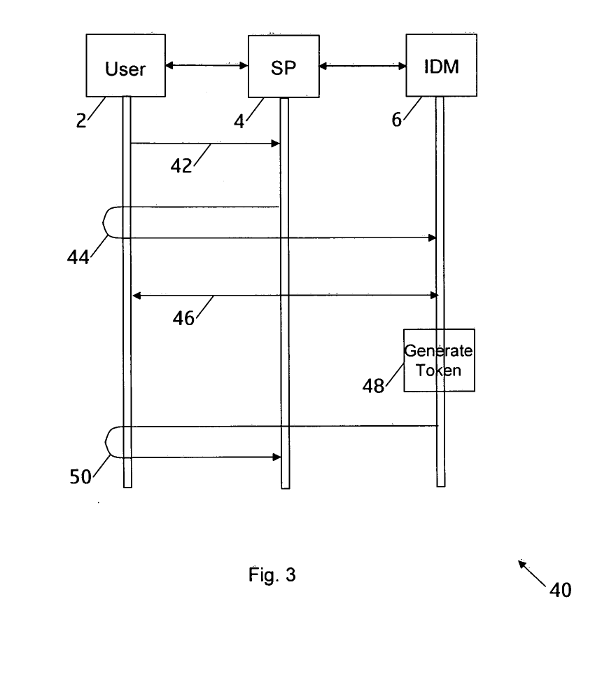

The request 14 included in the algorithm 10 needs to identify the user 2 so that the IDM 6 can authenticate that user. The user details could, for example, simply be included in the message 14. FIG. 3 shows a message sequence, indicated generally by the reference numeral 40, in which the identification of the user 2 is achieved using redirection.

The message sequence 40 starts at step 42 where the user 2 logs into a user account at the service provider 4 (this step is similar to the step 12 described above). Next the service provider sends a request 44 to the IDM 6 requesting an account recovery token. The request 44 is sent via the user 2 using redirection. Accordingly, the request 44 is received at the IDM 6 from the user 2. The source of the message (the user 2) can therefore be used to identify the user.

In response to the request 44, the IDM 6 contacts the user 2 and authenticates the user (step 46, which step is similar to the step 16 described above).

Once the IDM 6 has authenticated the user 2, the IDM generates and stores a recovery token (at step 48). The IDM 6 then sends the recovery token to the service provider 4 in a message 50, which message is sent in response to the original request 44. The message 50 is sent to the service provider 4 via the user 2 using redirection.

As described above, the user credentials recovery process of the present invention includes two stages: registering (as described above) and recovery. The recovery process happens when the user indicates to the service provider that the s/he cannot provide the required login information. For example, the user may be able to provide a username (thereby identifying the user account in question) but may not be able to provide the required password (such that the required user credentials are not provided). Alternatively, the user may not be able to provide any credentials (for example, both the username and password of a username/password pair may have been forgotten).

As discussed above, the recovery process involves the service provider 4 asking the IDM 6 to provide the relevant account recovery token. The IDM 6 provides the recovery token after authenticating the user. Assuming that the token received from the IDM matches an account recovery token stored locally at the service provider, the service provider provides the user with access to the account.

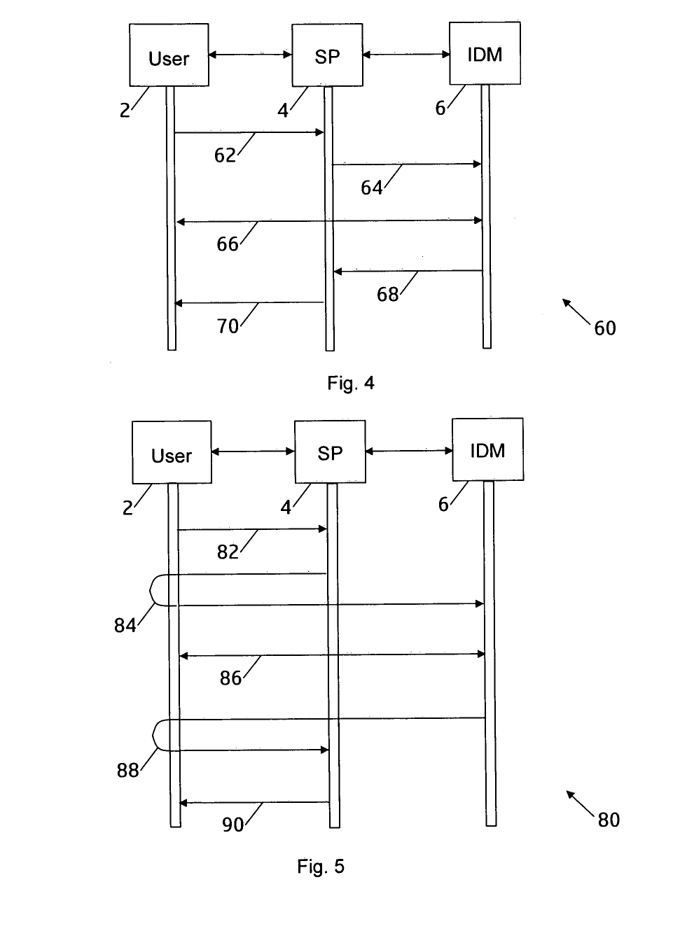

By way of example, FIG. 4 shows a message sequence, indicated generally by the reference numeral 60, of an exemplary recovery process in accordance with an aspect of the present invention.

The message sequence 60 starts at step 62, where the user sends an account recovery request to the service provider 4. The service provider 4 may, for example, provide a selectable link as part of a graphical user interface entitled “account recovery” or something similar for this purpose.

In response to the request 62, the service provider 4 sends an account recovery token request 64 to the IDM 6. In order to do so, the service provider must know how to contact the IDM 6. The identification details for the IDM may be provided by the user 2, for example in the form of a URL included in the request 62. Alternatively, in response to the request 62, the service provider 4 may prompt the user 2 to indicate which IDM to use. In one form of the invention, the service provider 4 may provide a list of possible IDMs, from which the user 2 is required to select the desired IDM.

On receipt of the account recovery token request 64, the IDM 6 authenticates the user (step 66). Once the user is authenticated, the IDM 6 retrieves the recovery token and returns the recovery token to the service provider in a message 68. The recovery token is unique to the user 2 and the service provider 4. Since the request 64 is received from the service provider, the IDM can readily identify the service provider. Further, the user 2 has been authenticated at step 66 of the algorithm 60 and is therefore also known. Accordingly, the correct account recovery token can readily be retrieved by the IDM 6.

On receipt of the recovery token from the IDM 6, the service provider 4 compares the token with the one or more tokens stored at the service provider in order to identify the user account. In some forms of the invention, the service provider 4 may use the identity of the IDM 6 and the recovery token received from the IDM 6 to identify the user account, on the basis that for a particular IDM, the recovery token is unique to the user 2 and the service provider 4.

Once the user account has been identified by the service provider 4, the user account can be “recovered”. The recovery of the user account may take many forms, such as providing the user with the username and password for the account or prompting the user to change the password of the username/password pair. Once the user has been provided with access to the account, the account recovery process is complete.

The request 64 included in the algorithm 60 needs to identify the user 2 so that the IDM 6 can authenticate that user. The user details could, for example, simply be included in the message 64. FIG. 5 shows a message sequence, indicated generally by the reference numeral 80, in which the identification of the user 2 is achieved using redirection. The algorithm 80 therefore has some similarities with the algorithm 40 described above with reference to FIG. 3.

The message sequence 80 starts at step 82 where the user 2 sends an account recovery request to the service provider 4. The request 82 is similar to the request 62 described above. In response to the request 82, the service provider sends an account recovery token request 84 (similar to the request 64) to the IDM 6. The request 84 is sent via the user 2 using redirection. Accordingly, the request 84 is received at the IDM from the user 2. The source of the request (the user 2) can therefore be used to identify the user.

In response to the request 84, the IDM contacts the user 2 and authenticates the user (step 86, which step is similar to the step 66 described above).

Once the IDM 6 has authenticated the user 2, the IDM retrieves the recovery token and returns the recovery token to the service provider in a message 88 (similar to the message 68 described above). The message 88 is sent to the service provider via the user using redirection.

The request 84 must identify the service provider 4 in order for the IDM 6 to retrieve the correct recovery token. Of course, this is readily achieved, since the request 84 is sent by the service provider 4 and the service provider can therefore include the required identification information (in the required format) in the request 84.

As in the algorithm 60, on receipt of the recovery token from the IDM 6, the service provider 4 compares the token with the one or more account recovery tokens stored at the service provider and, in the event that matching tokens are found, the service provider grants the user 2 access to the user account corresponding to the matched token. For example, if the tokens match, the service provider 4 may send a message 90 prompting the user to change the password of the username/password pair for the user account corresponding to the account recovery token.

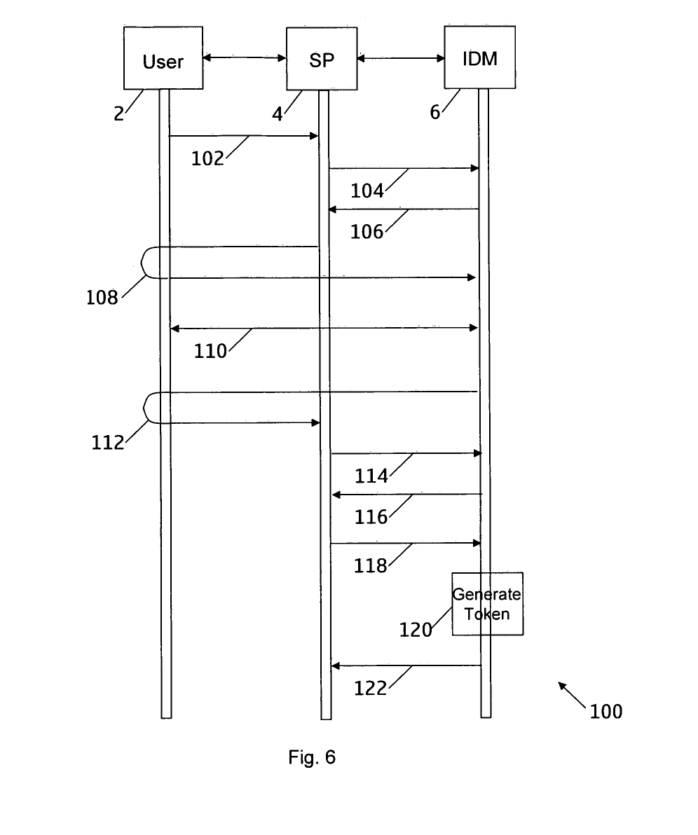

FIG. 6 is a message sequence, indicated generally by the reference numeral 100, showing an exemplary implementation of an algorithm for generating a message recovery token. The message sequence 100 is similar to the message sequence 40 described above with reference to FIG. 3, in particular in the respect that the request for an account recovery token is sent from the service provider 4 to the IDM 6 via the user 2.

The message sequence 100 differs from the message sequence 40 in the use of the well-known OAuth protocol. The OAuth protocol allows users to give third parties access to data stored at a particular service provider, without sharing access permission (such as username/password information).

As described in detail below, the service provider 4 requests and obtains an account recovery token from the IDM 6. The message sequence 100 is in accordance with the OAuth procedure, so that the service provider 4 initially obtains a request token from the IDM 6. The request token is authorised (by the user) and the service provider exchanges the authorised request token for an access token. The access token is used to obtain the account recovery token.

The message sequence 100 starts at step 102 where the user 2 sends a request for an account recovery token to the service provider 4. The request 102 is similar to the requests 12 and 42 described above.

In response to the request 102, the service provider seeks a request token from the IDM 6. (As before, the IDM 6 must be identified in some way, for example, by asking the user 2 to provide a URL for a suitable IDM.) The request token is requested in a message 104 sent from the service provider 4 to the IDM 6. The request token is provided by the IDM to the service provider in a message 106.

In accordance with the OAuth protocol, the request token is not user specific and does not provide the service provider 4 with authority to access user information at the IDM 6. In order to do so, the request token must be authorised by the user.

Next, at step 108 of the message sequence 100, the service provider 4 seeks permission from the user to obtain a recovery token from the IDM 6. The request 108 is sent to the IDM 6 via the user 2 using redirection. In response to the message 108, the IDM authenticates the user at step 110 of the message sequence 100. In this step, the user is also asked to authorise the request made by the service provider 4 to obtain a recovery token.

Assuming that the authorisation step 110 is successful, the IDM 6 returns an authorised request token to the service provider 4. The authorised request token is sent from the IDM 6 to the service provider 4 via the user 2 using redirection in a message 112.

In accordance with the OAuth protocol, the service provider is required to exchange the authorised request token for an access token before access can be granted to data stored at the IDM 6. Accordingly, the service provider 4 sends a request 114 to the IDM 6 to exchange the authorised request token for an access token. An access token is returned to the service provider 4 in message 116.

The service provider can now request the desired account recovery token and does so in a request 118, which request includes the access token. Next, the IDM 6 generates the account recovery token at step 120 (assuming a recovery token has not previously been generated) and returns the recovery token to the service provider 4 in message 122.

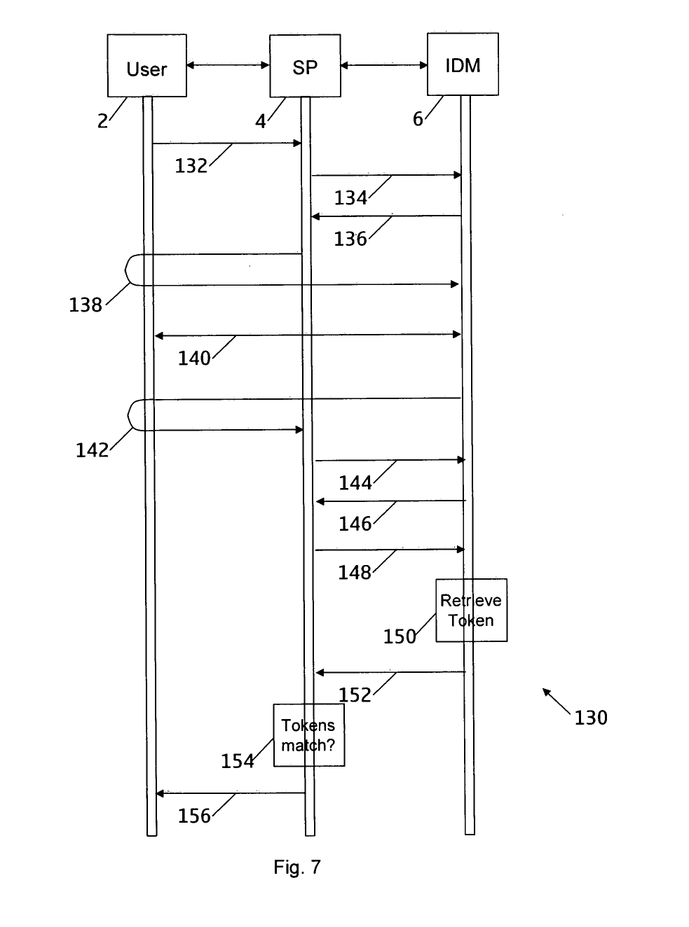

FIG. 7 is a message sequence, indicated generally by the reference numeral 130, showing an exemplary implementation of an algorithm for retrieving an account recovery token (such as an account recovery token generated using the message sequence 100 described above). The message sequence 130 is similar to the message sequence 80 described above with reference to FIG. 5, in particular in the respect that the request for an account recovery token is sent from the service provider 4 to the IDM 6 via the user 2. The message sequence 130 differs from the message sequence 80 in the use of the OAuth protocol.

The message sequence 130 starts at step 132 where the user 2 sends an account recovery request to the service provider 4. The request 132 is similar to the requests 62 and 82 described above. In response to the request 132, the service provider 4 seeks a request token from the IDM 6 by sending a request 134 for a request token. The IDM 6 duly returns a request token in the message 136. In accordance with the OAuth protocol, the request token is not user specific and does not provide the service provider 4 with authority to access user information at the IDM 6. In order to do so, the request token must be authorised by the user.

On receipt of the request token, the service provider 4 sends an account recovery token request 138 (similar to the requests 64 and 84) to the IDM 6. The request 138 is sent via the user 2 using redirection. In response to the message 138, the IDM authenticates the user at step 140 of the message sequence 130. In this step, the user is also asked to authorise the request made by the service provider 4 to obtain a recovery token.

Assuming that the authorisation step 140 is successful, the IDM 6 returns an authorised request token to the service provider 4. The authorised request token is sent from the IDM 6 to the service provider 4 via the user 2 using redirection in a message 142.

In accordance with the OAuth protocol, the service provider is required to exchange the authorised request token for an access token before access can be granted to data stored at the IDM 6. Accordingly, the service provider sends a request 144 to the IDM to exchange the authorised token for an access token. An access token is returned to the service provider 4 in message 146.

The service provider 4 can now request the desired account recovery token and does so in a request 148 sent to the IDM 6. Next, the IDM retrieves the requested account recovery token (step 150) and returns the recovery token to the service provider in a message 152 (similar to the messages 68 and 88 described above). The message 152 is sent to the service provider.

On receipt of the recovery token from the IDM 6, the service provider 4 compares the token (step 154) with the one or more tokens stored at the service provider and grants the user 2 access to the relevant service/user account, if matching tokens are found. For example, if the tokens match, the service provider 4 may send a message 156 prompting the user to change the password of the username/password pair.

A number of exemplary embodiments of the present invention have been described. The invention as described above provides a number of advantages over at least some of the prior art arrangements described above.

The present invention provides an account recovery mechanism in which the user's privacy is increased when compared with many prior art arrangements. For example, the user need not provide privacy information such as email account details, mobile phone number, birthday data, responses to common question etc, to the service provider.

The IDM 6 does not need to know any user identity information used at the service provider 4.

The user 2 does not need to remember anything to recover his/her account at a service provider 4. For example, in the event that the required user credentials are a username and password pair, a user who has forgotten both the username and the password can recover the account.

A user account that has been accessed by a hacker can be recovered, even if the hacker has reset the user credentials.

The solution is many ways more secure than existing solutions that rely on providing user credentials to a previously designated account, such as an email account or a mobile phone number.

The present invention provides a low cost, effective solution. For example, no additional SMS communication fees are required.

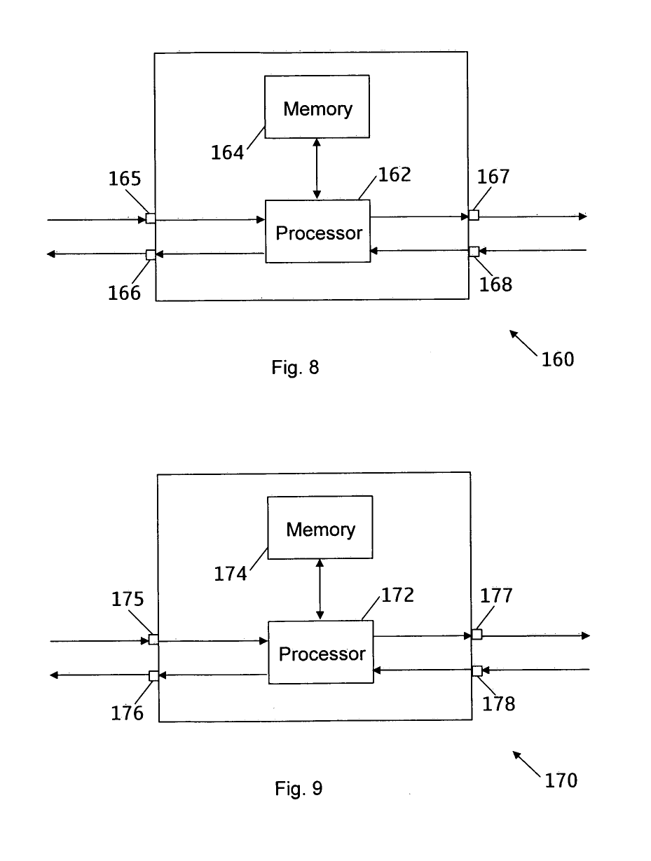

FIG. 8 is a simplified block diagram of an exemplary service provider 160 that may be used in some embodiments of the invention. The service provider 160 comprises a processor 162 and a memory 164. The processor 162 controls the functions of the service provider 160. The processor 162 is typically implemented with a microprocessor, a signal processor or separate components and associated software. The memory 164 may store various software and data required in the operation of the service provider 160. The memory may be integrated into the processor, or may be provided separately, as shown in FIG. 8.

FIG. 9 is a simplified block diagram of an exemplary identity management system 170 that may be used in some embodiments of the invention. The identity management system 170 comprises a processor 172 and a memory 174. The processor 172 controls the functions of the identity management system 170. The processor 172 is typically implemented with a microprocessor, a signal processor or separate components and associated software. The memory 174 may store various software and data required in the operation of the identity management system 170. The memory may be integrated into the processor, or may be provided separately, as shown in FIG. 9.

The service provider 160 includes a first input 165, a first output 166, a second output 167 and a second input 168. The identity management system 170 includes a first input 175, a first output 176, a second output 177 and a second input 178.

In use, the first input 165 and first output 166 of the service provider 160 are used to communicate with the user 2, for example to receive login credentials, or to receive a request for account recovery from the user.

The second output 167 and second input 168 of the service provider are used to communicate with the identity management system 170 and the first input 175 and first output 176 of the identity management system 170 are used to communicate with the service provider 160. Thus, the service provider 160 and the identity management system 170 are able to communicate as required by the algorithms described above with reference to FIGS. 2 to 7.

The second output 177 and second input 178 of the identity management system 170 are used to communicate with the user 2. This may be required, for example, to enable the service provider 160 and the identity management system 170 to communicate via the user 2 using redirection.

The embodiments described above show the recovery token being generated by the IDM 6 and being sent from the IDM to the service provider 4. This is not essential to all forms of the invention. For example, the recovery token could be generated by the service provider 4 and sent from the service provider to the IDM 6.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the spirit and scope of the appended claims.

1. A method comprising:
receiving, at a service provider, an account recovery request;
sending a request for a first account recovery token to an identity management system;
receiving the first account recovery token from said identity management system;
comparing the received first account recovery token with one or more second account recovery tokens to which the service provider has access; and
in the event that one of said one or more second account recovery tokens matches said first account recovery token, recovering a user account associated with said one of said one or more second account recovery tokens.

2. A method as claimed in claim 1, wherein recovering the user account comprises prompting the user to reset a credential for the user account.

3. A method as claimed in claim 1, wherein recovering the user account comprises informing the user of at least some credentials for the user account.

4. A method as claimed in claim 1, further comprising prompting the user to identify the identity management system.

5. A method as claimed in any preceding claim 1, wherein the account recovery request is initiated by a user.

6. A method as claimed in claim 5, wherein the request for a first account recovery token identifies the said user.

7. A method as claimed in claim 5, wherein the request for a first account recovery token is sent to the identity management system via the user.

8. A method comprising:
receiving, at an identity management system, a request for a first account recovery token associated with a user;
authenticating the user;
retrieving the first account recovery token based on the identity of the user and based on the identity of a service provider requesting said first account recovery token; and
sending the retrieved first account recovery token in response to said request.

9. A method as claimed in claim 8, wherein the request for a first account recovery token identifies said user.

10. A method as claimed in claim 8, wherein the request for a first account recovery token is sent from a service provider to the identity management system via the user using redirection.

11. A method as claimed in claim 1, wherein the first account recovery token is created as part of an account setup procedure.

12. An apparatus comprising:
a first input configured to receive an account recovery request;
a first output configured to send a request for a first account recovery token to an identity management system;
a second input configured to receive the first account recovery token from said identity management system;
a first processor configured to compare the first account recovery token with one or more second account recovery tokens to which the service provider has access; and
a second processor configured, in the event that one of said one or more second account recovery tokens matches said first account recovery token, to recover a user account associated with said one of said one or more second account recovery tokens.

13. An apparatus comprising:
a first input configured to receive a request for a first account recovery token associated with a user;
a first processor configured to authenticate said user;
a second processor configured to retrieve the first account recovery token based on the identity of the user and based on the identity of a service provider requesting said first account recovery token; and
a first output configured to send said retrieved first account recovery token in response to said request.

14. A computer program product comprising:
means for receiving, at a service provider, an account recovery request;
means for sending a request for a first account recovery token to an identity management system;
means for receiving the first account recovery token from said identity management system;
means for comparing the received first account recovery token with one or more second account recovery tokens to which the service provider has access; and
means for recovering, in the event that one of said one or more second account recovery tokens matches said first account recovery token, a user account associated with said one of said one or more second account recovery tokens.

15. A computer program product comprising:
means for receiving, at an identity management system, a request for a first account recovery token associated with a user;
means for authenticating a user;
means for retrieving the first account recovery token based on the identity of the user and based on the identity of a service provider requesting said first account recovery token; and
means for sending said retrieved first account recovery token in response to said request.
